(19) United States
(12) Patent Application Publication
(10) Pub. No.: US 2024/0056779 A1
(43) Pub. Date: Feb. 15, 2024

(54) MULTIMEDIA MESSAGING SERVICE (MMS) ANTISPAM SAFE LIST

(71) Applicant: T-Mobile Innovations LLC, Overland Park, KS (US)

(72) Inventors: Sarah Marie FLEMING, Winter Springs, FL (US); Chingming CHAO, Bellevue, WA (US)

(21) Appl. No.: 17/886,235

(22) Filed: Aug. 11, 2022

(51) Int. Cl. H04W 4/12; H04L 51/212; H04L 51/216

(52) U.S. Cl. CPC H04W 4/12; H04L 51/212; H04L 51/216; H04L 51/58

(57) ABSTRACT

Systems and methods for providing a safe sender list of one or more provider devices corresponding to one or more messages via a telecommunication network include a cell site and a safe sender system communicatively coupled to the cell site and a receiver device. The safe sender system to receive a message history including one or more messages, based on the message history, determine a subscriber relationship corresponding to one or more message exchanges between the receiver device and a provider device, the one or more message exchanges corresponding to a minimum exchange threshold, and generate a safe sender list including a provider identifier corresponding to the provider device in response to the determined subscriber relationship between the receiver device and the provider device.

### SUMMARY

The present disclosure is directed, in part, to providing a safe sender list of one or more provider devices corresponding to one or more messages via a telecommunication network, substantially as shown in and/or described in connection with at least one of the figures, and as set forth more completely in the claims.

In aspects set forth herein, a receiver device is connected to a telecommunication network. Typically, a message (e.g., a short message service (SMS) or multi-media service (MMS)) is sent to a receiver device. Because the message may contain spam or phishing tactics, the subscriber of the receiver device must review the message and determine whether it is safe to engage with the message. However, here, a safe sender system determines a subscriber relationship corresponding to one or more message exchanges between the receiver device and the provider device and generates a safe sender list that includes a provider identifier corresponding to the provider device, which reduces spam, scam, and phishing tactics while removing the manual determination by the subscriber of the receiver device.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Illustrative embodiments of the present invention are described in detail below with reference to the attached drawing figures, and wherein:

FIG. 1 depicts an example of a network environment in accordance with one or more embodiments;

FIG. 2 is a diagram of a network environment including a safe sender system in accordance with an example embodiment;

FIG. 3 depicts a flowchart of an exemplary method for providing a safe sender list of one or more provider devices corresponding to one or more messages via a telecommunication network in accordance with an example embodiment; and

FIG. 4 depicts an exemplary computing device suitable for use in implementations of aspects herein.

### DETAILED DESCRIPTION

The subject matter of embodiments of the invention is described with specificity herein to meet statutory requirements. However, the description itself is not intended to limit the scope of this patent. The claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

In certain aspects, methods are provided for providing a safe sender list of one or more provider devices corresponding to one or more messages via a telecommunication network. A message history including one or more messages is received. Based on the message history, a subscriber relationship corresponding to one or more message exchanges between the receiver device and a provider device is determined. The one or more message exchanges correspond to a minimum exchange threshold. A safe sender list including a provider identifier corresponding to the provider device is generated in response to the determined subscriber relationship between the receiver device and the provider device.

Advantageously, providing a safe sender list of one or more provider devices corresponding to one or more messages automatically generates a safe sender list, which removes the manual effort required by a subscriber.

In one aspect, a method is provided for providing a safe sender list of one or more provider devices corresponding to one or more messages via a telecommunication network. The method includes receiving, via a safe sender system communicatively coupled to a receiver device, a message history including one or more messages. The method also includes based on the message history, determining a subscriber relationship corresponding to one or more message exchanges between the receiver device and a provider device. The one or more message exchanges corresponding to a minimum exchange threshold. The method further includes generating a safe sender list including a provider identifier corresponding to the provider device in response to the determined subscriber relationship between the receiver device and the provider device.

In another aspect, a computer-readable storage media having computer-executable instructions embodied thereon is provided that, when executed by one or more processors, cause the processors to perform various steps. The processors are caused to receive, via a safe sender system communicatively coupled to a receiver device, a message history including one or more messages. The processors are also caused to, based on the message history, determine a subscriber relationship corresponding to one or more message exchanges between the receiver device and a provider device. The one or more message exchanges correspond to a minimum exchange threshold. The processors are further caused to add a provider identifier corresponding to the provider device to a safe sender list in response to the determined subscriber relationship between the receiver device and the provider device.

In yet another aspect, a system is provided for providing a safe sender list of one or more provider devices corresponding to one or more messages via a telecommunication network. The system includes a cell site and a safe sender system communicatively coupled to the cell site and a receiver device. The safe sender system receives a message history including one or more messages. The safe sender system also determines a subscriber relationship corresponding to one or more message exchanges between the receiver device and a provider device based on the message history. The one or more message exchanges correspond to a minimum exchange threshold. The safe sender system further generates a safe sender list including a provider identifier corresponding to the provider device in response to the determined subscriber relationship between the receiver device and the provider device.

Throughout this disclosure, several acronyms and shorthand notations are used to aid the understanding of certain concepts pertaining to the associated system and methods. These acronyms and shorthand notations are intended to help provide an easy methodology of communicating the ideas expressed herein and are not meant to limit the scope of aspects herein.

Embodiments herein may be embodied as, among other things: a method, system, or set of instructions embodied on one or more computer-readable media. Computer-readable media include both volatile and nonvolatile media, removable and non-removable media, and contemplate media readable by a database, a switch, and various other network devices. Computer-readable media includes media implemented in any way for storing information. Examples of stored information include computer-useable instructions, data structures, program circuitry, and other data representations. Media examples include RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently. Embodiments may take the form of a hardware embodiment, or an embodiment combining software and hardware. Some embodiments may take the form of a computer-program product that includes computer-useable or computer-executable instructions embodied on one or more computer-readable media.

“Computer-readable media” may be any available media and may include volatile and nonvolatile media, as well as removable and non-removable media. By way of example, and not limitation, computer-readable media may include computer storage media and communication media.

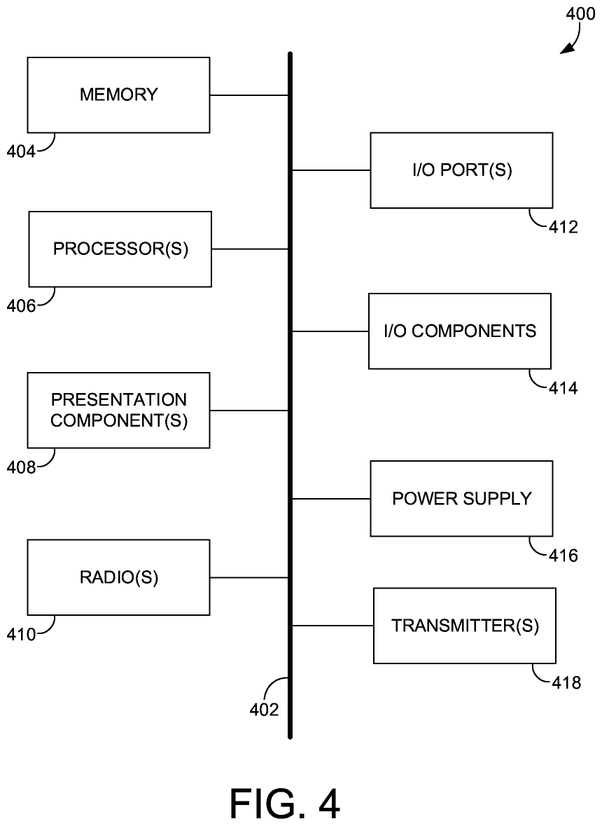

“Computer storage media” may include, without limitation, volatile and nonvolatile media, as well as removable and non-removable media, implemented in any method or technology for storage of information, such as computer-readable instructions, data structures, program circuitry, or other data. In this regard, computer storage media may include, but is not limited to, Random Access Memory (RAM), Read-Only Memory (ROM), Electrically Erasable Programmable Read-Only Memory (EEPROM), flash memory or other memory technology, CD-ROM, digital versatile disks (DVDs) or other optical disk storage, magnetic cassettes, magnetic tape, magnetic disk storage, or other magnetic storage devices, or any other medium which may be used to store the desired information and which may be accessed by the computing device 400 shown in FIG. 4. Computer storage media does not comprise a signal per se.

“Communication media” may include, without limitation, computer-readable instructions, data structures, program circuitry, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above also may be included within the scope of computer-readable media.

The terms “user equipment,” “UE,” “provider device,” “receiver device,” and “user device” are used interchangeably to refer to a device employed by an end-user that communicates using a network. UE generally includes one or more antenna coupled to a radio for exchanging (e.g., transmitting and receiving) transmissions with a nearby base station, via an antenna array of the base station. In embodiments, the UE may take on any variety of devices, such as a personal computer, laptop computer, tablet, netbook, mobile phone, smart phone, personal digital assistant, wearable device, augmented reality device, fitness tracker, or any other device capable of communicating using one or more resources of the network. The UE may include components such as software and hardware, a processor, a memory, a display component, a power supply or power source, a speaker, a touch-input component, a keyboard, and the like. In embodiments, some of the UE discussed herein may include current UE capable of using 5G or 6G and having backward compatibility with prior access technologies, current UE capable of using 5G or 6G and lacking backward compatibility with prior access technologies, and legacy UE that is not capable of using 5G or 6G.

A “network” refers to a network comprised of wireless and wired components that provide wireless communications service coverage to one or more UE. The network may comprise one or more base stations, one or more cell sites (i.e., managed by a base station), one or more cell towers (i.e., having an antenna) associated with each base station or cell site, a gateway, a backhaul server that connects two or more base stations, a database, a power supply, sensors, and other components not discussed herein, in various embodiments.

The terms “base station” and “cell site” may be used interchangeably herein to refer to a defined wireless communications coverage area (i.e., a geographic area) serviced by a base station. It will be understood that one base station may control one cell site or alternatively, one base station may control multiple cell sites. As discussed herein, a base station is deployed in the network to control and facilitate, via one or more antenna arrays, the broadcast, transmission, synchronization, and receipt of one or more wireless signals in order to communicate with, verify, authenticate, and provide wireless communications service coverage to one or more UE that request to join and/or are connected to a network.

An “access point” may refer to hardware, software, devices, or other components at a base station, cell site, and/or cell tower having an antenna, an antenna array, a radio, a transceiver, and/or a controller. Generally, an access point may communicate directly with user equipment according to one or more access technologies (e.g., 3G, 4G, LTE, 5G, mMIMO) as discussed hereinafter.

The terms “radio,” “controller,” “antenna,” and “antenna array” are used interchangeably to refer to one or more software and hardware components that facilitate sending and receiving wireless radio-frequency signals, for example, based on instructions from a base station. A radio may be used to initiate and generate information that is then sent out through the antenna array, for example, where the radio and antenna array may be connected by one or more physical paths. Generally, an antenna array comprises a plurality of individual antenna elements. The antennas discussed herein may be dipole antennas, having a length, for example, of ¼, ½, 1, or 1½ wavelength. The antennas may be monopole, loop, parabolic, traveling-wave, aperture, yagi-uda, conical spiral, helical, conical, radomes, horn, and/or apertures, or any combination thereof. The antennas may be capable of sending and receiving transmission via FD-MIMO, Massive MIMO, 3G, 4G, 5G, and/or 802.11 protocols and techniques.

Additionally, it will be understood that terms such as “first,” “second,” and “third” are used herein for the purposes of clarity in distinguishing between elements or features, but the terms are not used herein to import, imply, or otherwise limit the relevance, importance, quantity, technological functions, sequence, order, and/or operations of any element or feature unless specifically and explicitly stated as such.

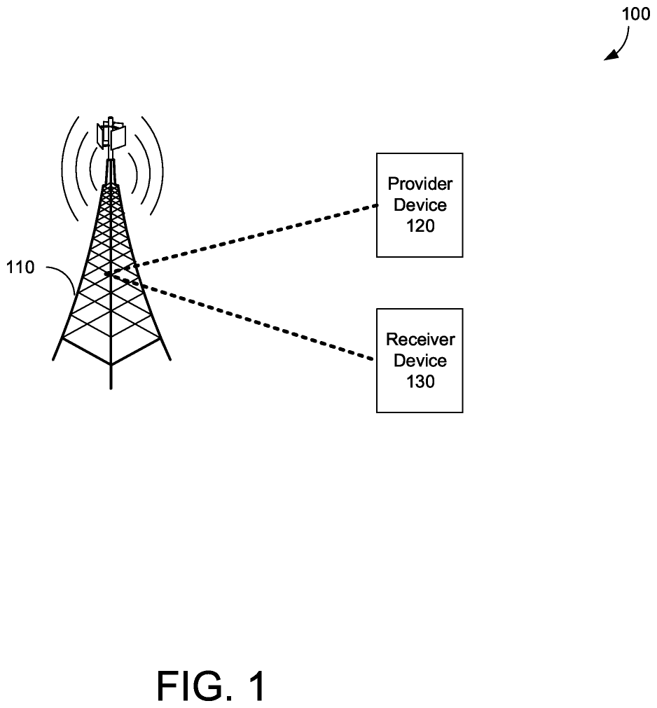

FIG. 1 illustrates an example of a network environment 100 suitable for use in implementing embodiments of the present disclosure. The network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

The network environment 100 provides service to one or more devices 120 and 130. In some embodiments, the network environment 100 may include a telecom network (e.g., a telecommunication network such as, but not limited to, a wireless telecommunication network), or portion thereof. The network environment 100 may include one or more devices and components, such as base stations, servers, switches, relays, amplifiers, databases, nodes, etc. which are not shown so as to not confuse other aspects of the present disclosure. Those devices and components may provide connectivity in a variety of implementations. In addition the network environment 100 may be utilized in a variety of manners, such as a single network, multiple networks, or as a network of networks, but, ultimately, is shown as simplified as possible to avoid the risk of confusing other aspects of the present disclosure.

The telecom network included in the network environment 100 may include or otherwise may be accessible through a cell site (e.g., the cell site 110). The cell site may include one or more antennas, base transmitter stations, radios, transmitter/receivers, digital signal processors, control electronics, GPS equipment, power cabinets or power supply, base stations, charging stations, etc. such that the cell site may provide a communication link between one or more user devices (e.g., one or more provider devices and/or receiver devices such as the devices 120 and 130) and other components, systems, equipment, and/or devices of the network environment 100. The base station and/or a computing device (e.g., whether local or remote) associated with the base station may manage or otherwise control the operations of components of the cell site.

In some embodiments, the cell site may be operable in a non-stand alone (NSA) mode. In the non-stand alone mode the network environment 100 may take the form of, for example, an E-UTRAN New Radio-Dual Connectivity (EN-DC) network. In an EN-DC network, a provider device and/or a receiver device may connect to or otherwise access a 4G, LTE, 5G, or any other suitable network simultaneously. In the stand alone mode, the telecom network may take the form of a 5G, 6G, or any other suitable network.

In some embodiments, the network environment 100 may include one or more nodes communicatively coupled to one or more provider devices (e.g., the provider device 120) and one or more receiver devices (e.g., the receiver device 130) such that the node(s) may transmit to and receive requests and/or data from the provider device(s) and/or the receiver device(s). The one or more nodes may include a Next Generation Node B (e.g., gNodeB or gNB) or any other suitable node. The one or more nodes may correspond to one or more frequency bands within which the provider device(s) and/or the receiver device(s) may connect to the network environment such as, but not limited to, a telecommunication network or a portion thereof.

In some embodiments, the node(s) may be included within the cell site (e.g., the cell site 110), external to the cell site, or otherwise communicatively coupled to the cell site. The node(s) may allocate radio frequency, or a portion thereof, to user device(s).

In some embodiments, the provider device(s) and/or the receiver device(s) may take the form of a wireless or mobile device capable of communication via the network environment 100. For example, the receiver device 130 may take the form of a mobile device capable of communication via a telecom network such as, but not limited to, a wireless telecommunication network. In this regard, the provider device(s) and/or the receiver device(s) may be any computing device that communicates by way of a network, for example, a 4G, LTE, WiMAX, Wi-Fi, 5G, 6G, or any other type of network.

In some embodiments, the network environment 100 may connect subscribers (e.g., current subscribers and/or potential subscribers) to a service provider or a plurality of service providers. Alternatively or additionally, the network environment 100 may be associated with a specific telecommunication provider or a plurality of telecommunication providers that provide services (e.g. 5G, 6G, voice, location, data, etc.) to one or more user devices. For example, the provider device 120 and/or the receiver device 130 may be subscribers to a telecommunication service provider, in which the devices are registered or subscribed to receive voice and data services (e.g., receive content that may be streamed, downloaded, etc.) over the network environment 100. The network environment 100 may include any communication network providing voice and/or data service(s), such as, for example, a Wi-Fi network, 4G network (LTE, WiMAX, HSDPA), 5G network, or 6G network.

Having described the network environment 100 and components operating therein, it will be understood by those of ordinary skill in the art that the network environment 100 is but one example of a suitable network and is not intended to limit the scope of use or functionality of aspects described herein. Similarly, the network environment 100 should not be interpreted as imputing any dependency and/or any requirements with regard to each component and combination(s) of components illustrated in FIG. 1. It will be appreciated by those of ordinary skill in the art that the number, interactions, and physical location of components illustrated in FIG. 1 are examples, as other methods, hardware, software, components, and devices for establishing one or more communication links between the various components may be utilized in implementations of the present invention. It will be understood to those of ordinary skill in the art that the components may be connected in various manners, hardwired or wireless, and may use intermediary components that have been omitted or not included in FIG. 1 for simplicity's sake. As such, the absence of components from FIG. 1 should not be interpreted as limiting the present invention to exclude additional components and combination(s) of components. Moreover, though components may be represented as singular components or may be represented in a particular quantity in FIG. 1, it will be appreciated that some aspects may include a plurality of devices and/or components such that FIG. 1 should not be considered as limiting the quantity of any device and/or component.

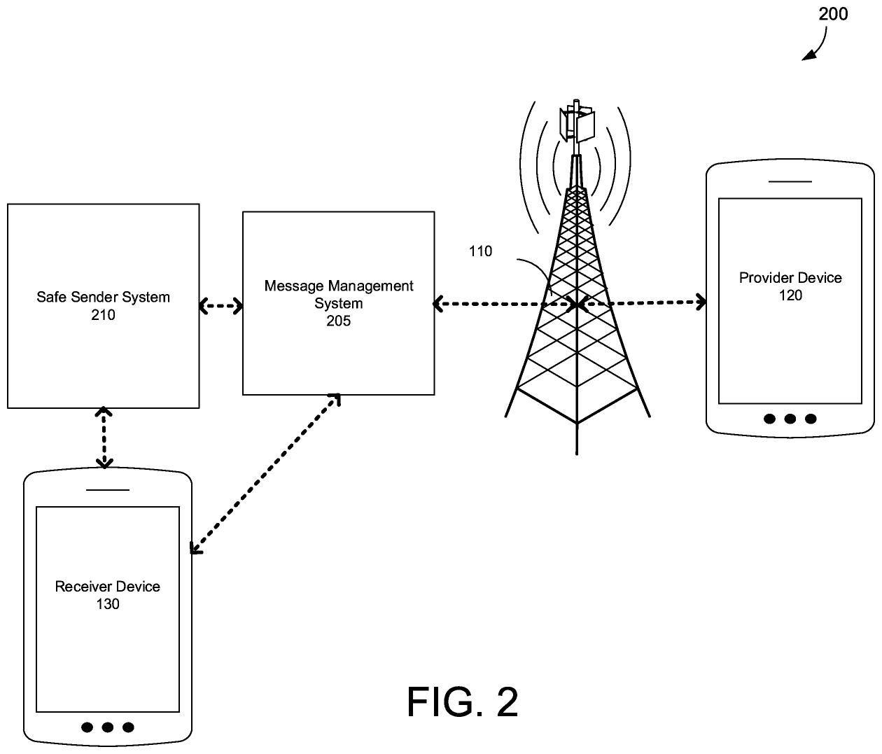

FIG. 2 is a diagram of the network environment 200 (e.g., a telecommunication environment such as, but not limited to, a wireless telecommunication environment) according to an example embodiment. In the present embodiment, the network environment 200 includes the cell site 110, provider device 120, receiver device 130, message management system 205, and safe sender system 210. The safe sender system may be communicatively coupled to the receiver device, provider device, message management system, or any other suitable system. Although some of the components in the network environment 200 are depicted as single components (e.g., a single provider device, message management system, cell site, etc.), in some embodiments, the network environment 200 may include a plurality of such components.

In some embodiments, the safe sender system may receive a message history that includes one or more messages. The message history may be received in real-time or near real-time. The one or more messages may include at least one of a short message service (SMS), multi-media service (MMS), or rich communication service (RCS). The message management system 205 may include or otherwise take the form of a SMSC (Short Message Service Center), a server that processes SMS messaging. In other embodiments, the message management system 205 may include or otherwise take the form of a MMSC (Multimedia Messaging Service Center), the server that processes MMS messaging. The receiver device 130 may include a message interface that may output or otherwise display the message(s) on the receiver device. A user (e.g., a subscriber) of the receiver device and/or the provider device may select, press, or tap the message(s).

The safe sender system 210 may check or otherwise determine whether the message history includes antispam. The message(s) may include antispam (e.g., content that does not include or otherwise is not related to spam, a scam, or a phishing attack) and/or spam (e.g., content that includes or otherwise is related to spam, a scam, or a phishing attack). The antispam may correspond to a trusted status. Spam may correspond to an untrusted status. The safe sender system may track the number of message(s) associated with a trusted status. For example, the provider device 120 (e.g., Originator A) may send X number of messages (e.g., SMS, MMS, and/or RCS messages) that are checked, by the safe sender system 210, for antispam. If the safe sender system 210 determines that the message(s) include antispam, the safe sender system 210 may assign a trusted status to the message(s). The safe sender system 210 may provide the one or more messages that are trusted to the receiver device 130. If the message(s) are assigned the trusted status, any future message(s) (e.g., SMS messages) from the provider device 120 (e.g., Originator A) may no longer be sent for an antispam check. For example, one or more subsequent messages corresponding to or otherwise from the provider device 120 may bypass the check for antispam.

In some embodiments, the safe sender system 210 may, based on the message history, determine a subscriber relationship corresponding to one or more message exchanges between the receiver device 130 and the provider device 120. A “subscriber relationship” may be used herein to refer to a consistent interaction between the provider device and the receiver device based on a plurality of messages (e.g., multiple SMS exchanges). A subscriber relationship may not be established if one or more messages (e.g., one or more SMS messages) are received by the receiver device, but the receiver device does not respond.

As used herein, the term “message exchange” may include at least one message response from the receiver device to the message(s) provided by the provider device. The message exchange(s) may correspond to a minimum exchange threshold. The minimum exchange threshold may identify a minimum number of message exchanges that must occur to add the provider device 120 to the safe list of the receiver device 130. In some embodiments, the minimum exchange threshold may be static (e.g., a set number) or dynamic (e.g., a variable or configurable number). For example, the minimum exchange threshold may be dynamic such that machine learning and/or a programmatic algorithm may determine the minimum exchange threshold.

In some examples, the safe sender system 210 may generate a safe sender list that includes a provider identifier corresponding to the provider device 120 in response to the determined subscriber relationship between the receiver device 130 and the provider device 120. Accordingly, the safe sender system 210 may determine a provider identifier associated with the provider device 120. The provider identifier may include one or more numeric characters and/or alphabet characters. For example, the provider identifier may include at least one of a phone number, MSISDN, or any other suitable identifier. The provider identifier may identify a device (e.g., the provider device, etc.) to include in the safe sender list. In some embodiments, the receiver device 130 and/or the safe sender system 210 may include circuitry that looks up, via one or more databases, the provider identifier. Alternatively or additionally, once the safe sender system 210 determines that the message history includes message(s) that correspond to or otherwise meet the minimum exchange threshold (e.g., the minimum number of message(s) required to be exchanged between the receiver device 130 and the provider device 120 (e.g., two subscribers)), the provider identifier corresponding to the provider device 120 may be auto-added (e.g., automatically added) to the safe sender list generated by the safe sender system 210.

Advantageously, providing a safe sender list of one or more provider devices corresponding to one or more messages via a telecommunication network reduces spam, scam, and phishing tactics while automatically generating a safe sender list without manual tracking by a subscriber of a receiver device.

In some embodiments, the receiver device 130 may generate a message interface. The message interface generated may include the safe sender list, provider identifier, and/or any other identifier associated with the provider device. The message interface may be communicatively coupled to and/or operable via one or more APIs. The APIs may provide or otherwise transmit the message(s), safe sender list, message interface, etc. between the safe sender system 210, message management system 205, and/or any other system, component, or circuitry of the telecommunications network (e.g., the telecommunication network 200).

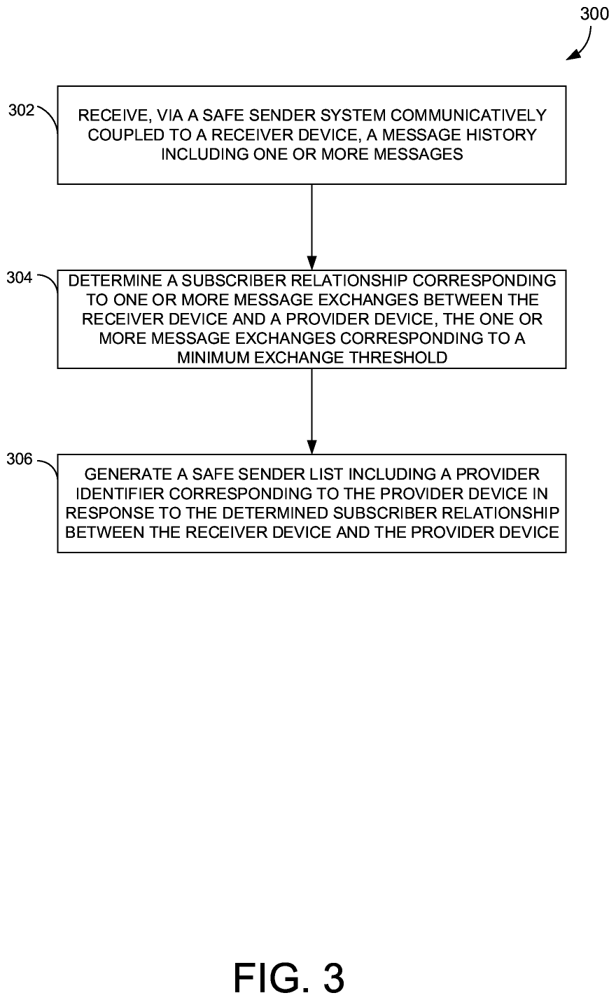

FIG. 3 depicts a flow diagram of an exemplary method 300 for providing a safe sender list of one or more provider devices corresponding to one or more messages via a telecommunication network, in accordance with implementations of the present disclosure. Initially at block 302 a message history that includes one or more messages is received by the safe sender system. The one or more messages may include, for example, a multi-media service (MMS) message. The safe sender system may determine whether the message history includes antispam (e.g., content that does not include a scam) or spam (e.g., content that includes a scam). The antispam may correspond to a trusted status. If the safe sender system determines that the message(s) include antispam, the safe sender system may assign a trusted status to the message(s). If the safe sender system determines that the message(s) include spam, the safe sender system may assign an untrusted status to the message(s).

At block 304, a subscriber relationship corresponding to one or more message exchanges between the receiver device and the provider device is determined based on the message history. The message exchange may include at least one message response from the receiver device to the message(s) provided by the provider device. In some examples, the message exchange(s) may correspond to a minimum exchange threshold that identifies a minimum number of message exchanges that must occur to add the provider device to the safe list of the receiver device.

In some embodiments, a safe sender list that includes a provider identifier corresponding to the provider device is generated in response to the determined subscriber relationship between the receiver device and the provider device at block 306. The safe sender system may determine the provider identifier (e.g., the phone number and/or MSISDN) associated with the provider device. The provider identifier corresponding to the provider device may be added (e.g., automatically added) to the safe sender list generated by the safe sender system in response to the determined subscriber relationship between the receiver device and the provider device.

Referring to FIG. 4, a block diagram of an example of a computing device 400 suitable for use in implementations of the technology described herein is provided. In particular, the exemplary computer environment is shown and designated generally as computing device 400. Computing device 400 is but one example of a suitable computing environment and is not intended to suggest any limitation as to the scope of use or functionality of the invention. Neither should computing device 400 be interpreted as having any dependency or requirement relating to any one or combination of components illustrated. In aspects, the computing device 400 may be a base station. In another embodiment, the computing device 400 may be UE capable of two-way wireless communications with an access point. Some non-limiting examples of the computing device 400 include a base station, a controller at a base station, a backhaul server, a personal computer, a cell phone, current UE, legacy UE, a tablet, a pager, a personal electronic device, a wearable electronic device, an activity tracker, a laptop, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 4, computing device 400 includes a bus 402 that directly or indirectly couples various components together. The bus 402 may directly or indirectly one or more of memory 404, processor(s) 406, presentation component(s) 408 (if applicable), radio(s) 410, input/output (I/O) port(s) 412, input/output (I/O) component(s) 414, power supply 416, and/or transmitter(s) 418. Although the components of FIG. 4 are shown with lines for the sake of clarity, in reality, delineating various components is not so clear, and metaphorically, the lines would more accurately be grey and fuzzy. For example, one may consider a presentation component(s) 408 such as a display device to be one of I/O components 414. Also, the processor(s) 406 may include memory 404, in another example. The present disclosure hereof recognizes that such is the nature of the art, and reiterates that FIG. 4 is merely illustrative of an example of a computing device 400 that may be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 404 may take the form of memory components described herein. Thus, further elaboration will not be provided here, but it should be noted that memory 404 may include any type of tangible medium that is capable of storing information, such as a database or data store. A database or data store may be any collection of records, files, or information encoded as electronic data and stored in memory 404, for example. In one embodiment, memory 404 may include a set of embodied computer-readable and executable instructions that, when executed, facilitate various functions or elements disclosed herein. These embodied instructions will variously be referred to as “instructions” or an “application” for short.

Processor(s) 406 may be multiple processors that receive instructions and process them accordingly. Presentation component(s) 408, if available, may include a display device, an audio device such as a speaker, and/or other components that may present information through visual (e.g., a display, a screen, a lamp (LED), a graphical user interface (GUI), and/or even lighted keyboards), auditory, and/or other tactile or sensory cues.

Radio(s) 410 represents one or more radios that facilitate communication with a wireless telecommunication network. For example, radio(s) 410 may be connected to one or more antenna elements through a physical path. Illustrative wireless telecommunications technologies include CDMA, GPRS, TDMA, GSM, and the like. Radio(s) 410 might additionally or alternatively facilitate other types of wireless communications including Wi-Fi, WiMAX, 3G, 4G, LTE, mMIMO, 5G, 6G, NR, VoLTE, and/or other VoIP communications. As can be appreciated, in various embodiments, radio(s) 410 may be configured to concurrently support multiple technologies, as previously discussed herein. As such, each of many radio(s) 410 may be used to separately control portions of an antenna array, for example, where at least one portion utilizes a distinct technology relative to another portion in the same antenna array or at the same base station or cell site. A wireless telecommunication network might include an array of devices, which are not shown so as to not obscure more relevant aspects of the invention. Components such as a base station, a communications tower, or even access points (as well as other components) can provide wireless connectivity in some embodiments.

The input/output (I/O) ports 412 may take a variety of forms. Exemplary I/O ports 412 may include a USB jack, a stereo jack, an infrared port, a firewire port, other proprietary communications ports, and the like. Input/output (I/O) components 414 may comprise keyboards, microphones, speakers, touchscreens, and/or any other item usable to directly or indirectly input data into the computing device 400.

Power supply 416 may include batteries, fuel cells, and/or any other component that may act as a power source to supply power to the computing device 400 or to other network components, including through one or more electrical connections or couplings. Power supply 416 may be configured to selectively supply power to different components independently and/or concurrently.

Finally, regarding FIGS. 1 through 4, it will be understood by those of ordinary skill in the art that the environment(s), system(s), and/or methods(s) depicted are not intended to limit the scope of use or functionality of the present embodiments. Similarly, the environment(s), system(s), and/or methods(s) should not be interpreted as imputing any dependency and/or any requirements with regard to each component, each step, and combination(s) of components or step(s) illustrated therein. It will be appreciated by those having ordinary skill in the art that the connections illustrated the figures are contemplated to potentially include methods, hardware, software, and/or other devices for establishing a communications link between the components, devices, systems, and/or entities, as may be utilized in implementation of the present embodiments. As such, the absence of component(s) and/or steps(s) from the figures should be not be interpreted as limiting the present embodiments to exclude additional component(s) and/or combination(s) of components. Moreover, though devices and components in the figures may be represented as singular devices and/or components, it will be appreciated that some embodiments can include a plurality of devices and/or components such that the figures should not be considered as limiting the number of devices and/or components.

It is noted that aspects of the present invention are described herein with reference to block diagrams and flowchart illustrations. However, it should be understood that each block of the block diagrams and/or flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

Additionally, as should be appreciated, various embodiments of the present disclosure described herein can also be implemented as methods, apparatus, systems, computing devices/entities, computing entities, and/or the like. As such, embodiments of the present disclosure can take the form of an apparatus, system, computing device, computing entity, and/or the like executing instructions stored on a computer-readable storage medium to perform certain steps or operations. However, embodiments of the present disclosure can also take the form of an entirely hardware embodiment performing certain steps or operations.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned may be completed without departing from the scope of the claims below. Certain features and sub-combinations are of utility and may be employed without reference to other features and sub-combinations and are contemplated within the scope of the claims.

The invention claimed is:

1. A method for providing a safe sender list of one or more provider devices corresponding to one or more messages via a telecommunication network, the method comprising:
receiving, via a safe sender system communicatively coupled to a receiver device, a message history comprising one or more messages;
based on the message history, determining a subscriber relationship corresponding to one or more message exchanges between the receiver device and a provider device, the one or more message exchanges corresponding to a minimum exchange threshold; and
generating a safe sender list comprising a provider identifier corresponding to the provider device in response to the determined subscriber relationship between the receiver device and the provider device.

2. The method of claim 1, wherein the one or more messages comprise at least one of a short message service (SMS), multi-media service (MMS), or rich communication service (RCS).

3. The method of claim 1, wherein the message history is received in real-time or near real-time.

4. The method of claim 1, further comprising checking the message history for antispam.

5. The method of claim 1, wherein the one or more messages comprise antispam, and wherein the antispam corresponds to a trusted status.

6. The method of claim 5, wherein the safe sender system tracks the number of the one or messages corresponding to the trusted status.

7. The method of claim 5, wherein the safe sender system is structured to provide the one or more messages to the receiver device.

8. The method of claim 1, wherein the one or more message exchanges comprise at least one message response from the receiver device to the one or more messages.

9. The method of claim 8, wherein at least one of the provider device or the receiver device is communicatively coupled to at least one of a 4G network, E-UTRAN New Radio-Dual Connectivity (EN-DC) network, 5G network, 6G network, or Wi-Fi network.

10. Computer-readable storage media having computer-executable instructions embodied thereon that, when executed by one or more processors, cause the one or more processors to:
receive, via a safe sender system communicatively coupled to a receiver device, a message history comprising one or more messages;
based on the message history, determine a subscriber relationship corresponding to one or more message exchanges between the receiver device and a provider device, the one or more message exchanges corresponding to a minimum exchange threshold; and
add a provider identifier corresponding to the provider device to a safe sender list in response to the determined subscriber relationship between the receiver device and the provider device.

11. The computer-readable storage media of claim 10, wherein the one or more messages comprise at least one of a short message service (SMS), multi-media service (MMS), or rich communication service (RCS).

12. The computer-readable storage media of claim 10, wherein the message history is received in real-time or near real-time.

13. The computer-readable storage media of claim 10, wherein the one or more messages comprise antispam, and wherein the antispam corresponds to a trusted status.

14. The computer-readable storage media of claim 10, wherein the one or more message exchanges comprise at least one message response from the receiver device to the one or more messages.

15. A system for providing a safe sender list of one or more provider devices corresponding to one or more messages via a telecommunication network, the system comprising:
a cell site; and
a safe sender system communicatively coupled to the cell site and a receiver device, the safe sender system to:
receive a message history comprising one or more messages;
based on the message history, determine a subscriber relationship corresponding to one or more message exchanges between the receiver device and a provider device, the one or more message exchanges corresponding to a minimum exchange threshold; and
generate a safe sender list comprising a provider identifier corresponding to the provider device in response to the determined subscriber relationship between the receiver device and the provider device.

16. The system of claim 15, wherein the one or more messages comprise at least one of a short message service (SMS), multi-media service (MMS), or rich communication service (RCS).

17. The system of claim 15, wherein the one or more messages comprise antispam, and wherein the antispam corresponds to the trusted status.

18. The system of claim 17, wherein the safe sender system is structured to provide the one or more messages to the receiver device.

19. The system of claim 15, wherein the safe sender system is structured to add the provider device to the safe list, and wherein one or more subsequent messages corresponding to the provider device bypass a check for antispam.

20. The system of claim 15, wherein the provider identifier comprises at least one of a phone number or MSISDN.
